(19) United States
(12) Patent Application Publication
(10) Pub. No.: US 2008/0242277 A1
(43) Pub. Date: Oct. 2, 2008

(54) COMMUNICATING COMMUNITY FEATURES FOR MOBILE ELECTRONIC DEVICES

(75) Inventors: Dennis Chen, Livermore, CA (US); Hudson George, Livermore, CA (US); Adam Lavine, Livermore, CA (US); Eric Allen, Livermore, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: FUNMOBILTIY INC., Livermore, CA (US)

(21) Appl. No.: 11/865,604

(22) Filed: Oct. 1, 2007

Related U.S. Application Data
(60) Provisional application No. 60/827,557, filed on Sep. 29, 2006.

(51) Int. Cl. H04M 3/42

(52) U.S. Cl. 455/414.2

(57) ABSTRACT

A method for social networking includes storing at least one profile on at least one server, the profile being associated with at least one local profile on a mobile device and wherein each of the profile and the local profile includes social networking information, receiving changes to one of the profile and the local profile, and synchronizing the profile and the local profile.

### RELATED APPLICATIONS

The present application claims priority to U.S. Provisional Application Ser. No. 60/827,557 filed Sep. 29, 2006 and entitled “COMMUNICATING COMMUNITY FEATURES FOR MOBILE ELECTRONIC DEVICES,” which is hereby incorporated by reference in its entirety.

### BACKGROUND OF THE INVENTION

1. The Field of the Invention

The invention generally relates to mobile electronic devices, and more particularly to systems and methods for linking information to or between mobile electronic devices.

2. Description of the Related Art

Advances in technology have resulted in a proliferation of electronic devices. Mobile wireless devices, such as cellular telephones and personal digital assistants, for example, have become an integral part of people's lives. The ability to communicate with others, including friends, coworkers, and family, at virtually any location has created a need for enhanced social features. Moreover, as people increase use of the features on their mobile electronic devices for entertainment and to access media content based on various interests, they also can be found to share experiences and their favorite media with others.

### BRIEF SUMMARY

According to one example, a method of providing a link to mobile content on a mobile device is provided that includes receiving a plurality of tags at the mobile device, each tag having at least one piece of mobile content associated therewith, and scrolling the plurality of tags across a portion of a display screen of a mobile device.

In another example, social networking information stored on a first mobile device can communicated to a second mobile device. Such a method may include transmitting voice data for reception by the second device and simultaneously transmitting at least a portion of the social networking information to the second mobile device. The social networking information may include a contact information presentation, such as a page of information about the user of the first mobile device.

A method of providing telephone service may include receiving voice information from a first mobile device, receiving social networking information simultaneously with receiving the voice information, and transmitting the voice information and the social networking information to a second mobile device.

In yet another example, a method for social networking may include receiving information linked to a first mobile electronic device subscribing to a wireless service, associating the first mobile electronic device with information stored from other mobile electronic devices based on the information received, querying information stored from the other mobile electronic devices, and transmitting a result of the query to the first mobile electronic device.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

In order to describe the manner in which the advantages and features of embodiments of the invention can be obtained, a more particular description of the subject matter briefly described above will be rendered by reference to specific embodiments, which are illustrated in the appended drawings. Understanding that these drawings depict only typical embodiments and are not, therefore, to be considered to be limiting in scope, embodiments will be described and explained with additional specificity and detail through the use of the accompanying drawings in which:

FIG. 1 is a schematic diagram of a social networking system according to one example;

FIG. 2 is a flowchart illustrating a method of synchronizing social networking information according to one example; and

FIGS. 3-14 illustrate presentations displaying social networking information that may be synchronized on a server and on a mobile device according to several examples.

### DESCRIPTION OF VARIOUS EMBODIMENTS

The principles of the embodiments described herein describe the structure and operation of various examples used to illustrate the present invention. It should be understood that the drawings are diagrammatic and schematic representations of such exemplary embodiments and, accordingly, are not limiting of the scope of the present invention, nor are the drawings necessarily drawn to scale. Well-known devices and processes have been excluded so as not to obscure the discussion in details that would be known to one of ordinary skill in the art.

Systems, devices, and methods are disclosed herein for communicating social networking information and/or preferences between one or more mobile devices, one or more servers, and other mobile devices. Examples of mobile electronic devices, by way of example and not limitation, can include mobile telephones, personal digital assistants, navigation devices, etc. Often, mobile electronic devices typically have the ability to access at least one network and may have the ability to interact with multiple types of networks and contents. A cellular telephone, for example, may be able to conduct voice communication over a wireless network as well as access the Internet.

Social networking can be described as the interaction between a user, and the user's friends and associates. More generally, social networking can be described as the interactions that can occur between individuals or among groups of individuals. Social networking can be based on various associations, such as family, friendship, hobbies, occupation, interests, etc. Embodiments disclosed herein relate to combining mobile productivity with social networking or social networking functionality such that users may become better connected. Advantageously, embodiments of the invention advance social networking on mobile devices and the various associations included in social networking can be created by users or associated automatically based on user input to a mobile electronic device. Social networking functionality broadens demographic reach creating mass appeal for customers. This appeal is created by use of a network of associated mobile electronic devices.

Members of the network are hereinafter referred to as “Insiders.” An Insider can be a subscriber to a particular wireless service plan to provide enhanced social networking functionality. The Insider can use a graphical user interface including a Main Menu presented on a display of their mobile electronic device to navigate through various feature-related presentations by selecting links or other graphically selectable options. The information and selectable options may be customized based on the features the user subscribes to or desires.

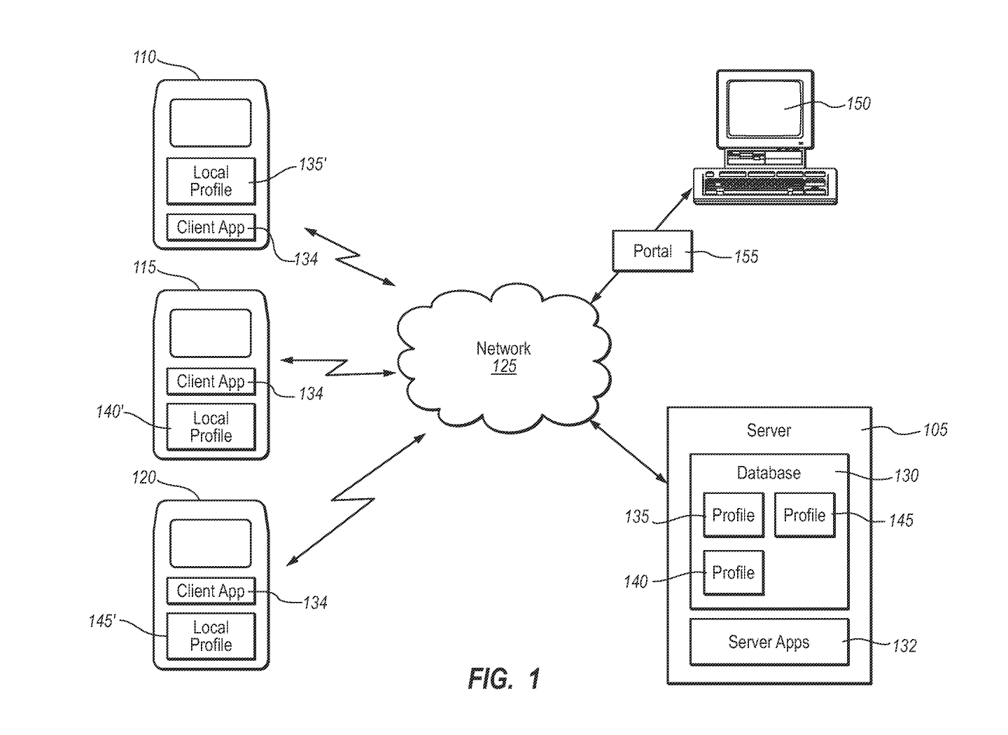

FIG. 1 is a schematic diagram of a social networking system 100 The social networking system 100 may generally include one or more server 105 that is configured to communicate with one or more mobile device 110, 115, 120 over a network 125. The server 105 may include a database 130. The database 130 or other portion of the server 105 may include a server application 132. The server application 132 may be configured to cooperate with one or more client application 134 residing on the mobile devices 110, 115, 120 to synchronize selected information that may be stored on the database 130. For example, the database 130 may have one or more user profiles 135, 140, 145 stored thereon. The profiles 135, 140, 145 include social networking information, such as information related to personal contact information, contact information for others including others within the social network, information related to media content including a user's interaction and preferences related to media content, reminders, and other information.

Device preferences and other device information may be related to the mobile devices 110, 115, 120. In one example, device information for each profile 135, 140, 145 may correspond to specific mobile devices that are in turn associated with a given user. Further, at least a portion of the information associated with each of the profiles 135, 140, 145 may be stored locally for use and/or display on the mobile devices 110, 115, 120. In particular, in the case of the mobile devices 110, 115, 120, local profiles 135′, 140′, 145′ may be stored on each of the mobile devices 110, 115, 120, which may be synchronized with the profiles 135, 140, 145 stored on the database 130.

The computing device 150 may be in communication with a portal 155 that in turn is in communication with a network, which is illustrated for ease of reference as the network 125. The portal 155 may be a web-based portal or other type of portal. The network 125 may be a cellular telephone network including a cellular communication link, the World Wide Web or another aspect of the Internet, a Local Area Network (LAN), or any other network or may represent multiple networks including the gateways that often link wireless telephone networks to the Internet. The mobile devices 110, 115, 120 may be connected to the network 125 via a wireless connection, such as a connection used in cellular telephone networks, an 802 xx connection, a Bluetooth connection, or any other wireless connection; or the mobile devices 110, 115, 120 may be connected to the network 125 via a wired connection.

Regardless of whether the local profiles 135′, 140′, 145′ are synched with the profiles 135, 140, 145 stored on the database 130, in at least one embodiment, the system 100 may allow mobile devices 110, 115, 120 to push a portion or all of the information associated with the local profiles 135′, 140′, 145′ to other mobile devices 110, 115, 120 when one mobile device communicates with another mobile device. For example, mobile device 110 may push a portion of local profile 135′, such as contact information including email address, a photograph, or other information, to mobile device 120 simultaneously with a voice call. In at least one example, such an operation may include making a data call over the network 125 at the same time the mobile device 110 makes a voice call using a telephone service.

Users may interact with the profiles 135, 140, 145 by way of the mobile devices 110, 115, 120 and/or by way of a computing device 150. For ease of reference, mobile device 110 and corresponding local profile 135′ and profile 135 will be discussed in the context of synchronizing the local profile 135′ and the profile 135 over the network 125.

In either case, a user may be able to access profile 135 over the network using either the mobile device 110 and/or the computing device 150 to modify and/or edit the information associated with her profile 135. As previously discussed, this information may include settings associated with the mobile devices 110. If the user accesses the profile 135 on the database 130, the server application 132 may store the changes to the profile 135 directly on the database 130.

Thereafter, the server application 132 may then communicate changes to the profile 135 and to mobile device 110 in order for the profile 135 to be synchronized with the local profile 135′. In at least one example, the server application 132 may send the updates to the mobile device 110 simultaneously with voice data sent to the mobile device 110, such as voice data that is sent as part of a conversation.

The mobile device 110 may receive the update, after which the client application 134 may make the appropriate changes to the local profile 135′ to thereby synchronize the local profile 135′ with the profile 135 stored on the database 130.

Similarly, the server application 132 and client application 134 may cooperate to synchronize changes made to the local profile 135′ with the profile 135 stored on the database 130. In particular, in at least one example changes may be made to the local profile 135′ directly on the mobile device 110. The client application 134 sends updates to the server 105 corresponding to the changes made to the local profile 135′. The server application 134 residing on the server 105 may then update the profile 135 to synchronize the profile 135 with the local profile 135′.

Information associated with a profile may include information such as posts, messages, or other information that is available to other users. The other users may include members of groups that users within the network create and/or to which users opt in. The server application 132 may also determine if the information pertinent to users in the group should be synched with the corresponding profiles. As a result, some updates to one profile may automatically be synched to other profiles and/or local profiles. Accordingly, the synchronization process may be described generally as including one sub-process of synchronizing social networking information in a first profile stored on a database with a corresponding first local profile stored on a mobile device and at least a second sub-process of synchronizing selected portions of additional profiles to reflect the changes to the first profile. The synchronization process of additional devices may then ripple through additional profiles or groups of profiles as desired. The synchronization process will be described first with reference from the server side of the system and then from the device side of the system.

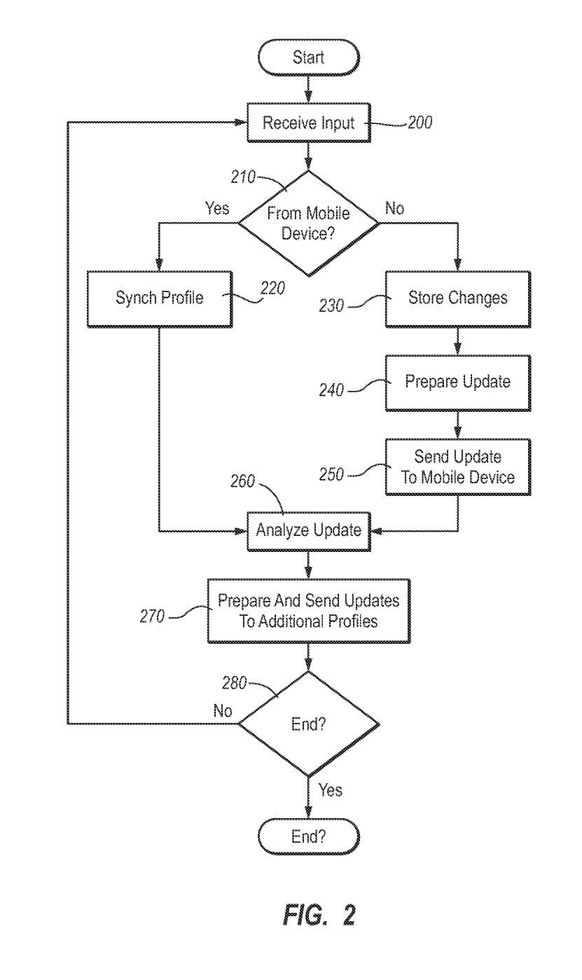

FIG. 2 is a flowchart illustrating one embodiment of a method of synchronizing social network information. Steps or acts described below may be omitted in some embodiments and/or may be performed in any order in some embodiments. The method begins at step 200 when the server receives input related to one or more profile. On the server side, the method may include at step 210 determining if the modification was received from a mobile device. The determination of whether the modification was received from a mobile device may depend on whether update information is received or whether modifications to the profile are being performed on a database or other part of the server. This determination can also be performed based on where the access request originates or in other identifying information that may be transmitted to the server. Update information from a mobile device may be sent as part of a set of information, which may be referred to collectively as an update. The update may include information used to synch the profile on the server, which may include changes made locally on the mobile device.

If the modifications to the profile are from a mobile device (YES, step 210), the profile may be synchronized at step 220 by implementing changes to the profile contained in the update. If the modifications to the profile are not from a mobile device (NO, step 210), the modifications are stored at step 230, and at step 240, the update is prepared for the corresponding mobile device or devices. Accordingly, the present method allows the server to synch a profile with input directly from a mobile device or from another source, such as a computing device. Once an update and/or other changes are received and implemented on the server device, the server sends an update to the mobile device at step 250 as appropriate. For example, an update to the profile that is received from a computing device typically results in an update to the user's mobile device in order to keep the profiles of the user synchronized. In at least one example, updates or other social networking information may be sent from the server to mobile devices when desired. In addition to synching the local profile on the mobile device with the profile on the server, the method may also allow for synching additional profiles in addition to the user's profile.

In particular, at step 260 the server may analyze the update and/or other information in the profile to determine which, if any, relationships exist between the updated profile and other profiles that are part of the social network. For example, if a user has selected media content as a favorite or otherwise interacted with media, the user's individual preferences with respect to the media may be stored in the user's profile while an aggregate profile of that particular media content may also be updated with the user's interaction.

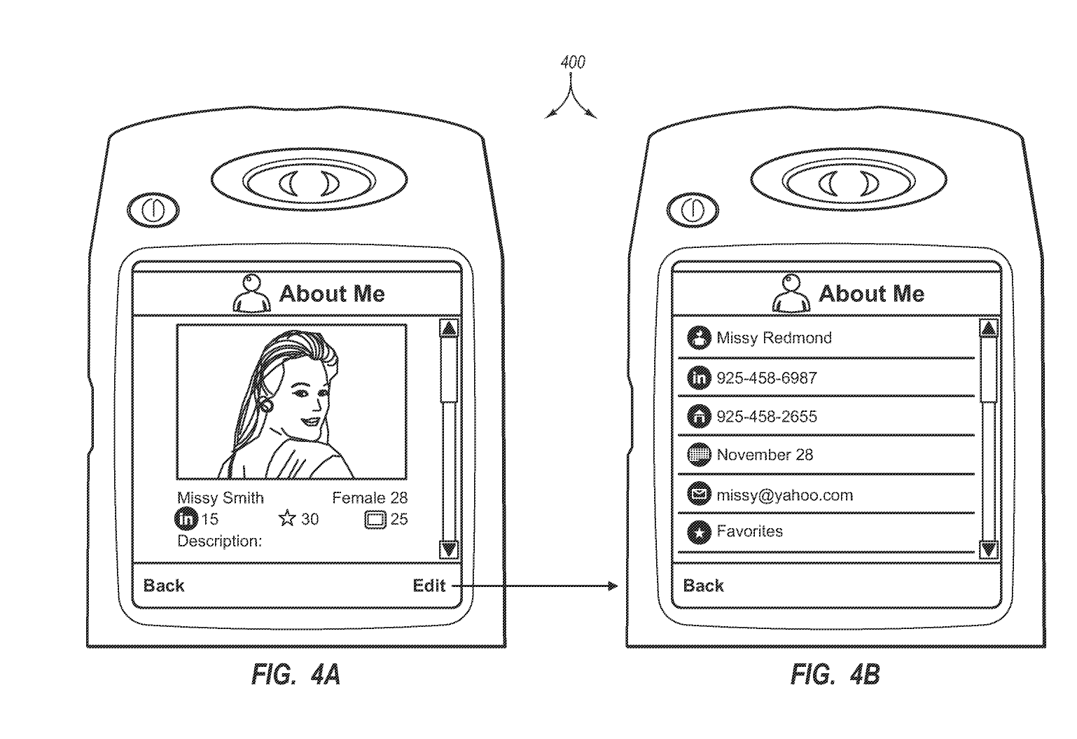

In another example, a user may post messages or other information to his profile while other users may subscribe to the news. In such an example, news posted to the user's profile will be saved and updating additional profiles may include notifying subscribers that the user has posted news to her profile. Additional examples of relationships between users and additional associated profiles are described in more detail below beginning with FIG. 4.

Still referring presently to FIG. 2, once relationships have been established between the updated profile and other profiles, the update may be parsed such that additional updates may be prepared for the other profiles to update the corresponding profiles as appropriate at step 270. If the method is to continue NO, determination 280, the method may continue at step 200.

These processes enable social networking to be more functional using personal electronic devices. The information can be automatically delivered to multiple profiles when the user updates his or her own profile. For example, a new email address or new contact information can be automatically updated to multiple profiles without requiring the user to take the additional step of sending emails and the like. Further, the recipients are not required to update their own data with the new data because the server sent the update automatically. This enables a particular user to continue to send emails to another user and be assured that the email will arrive even when the recipient's email address has changed.

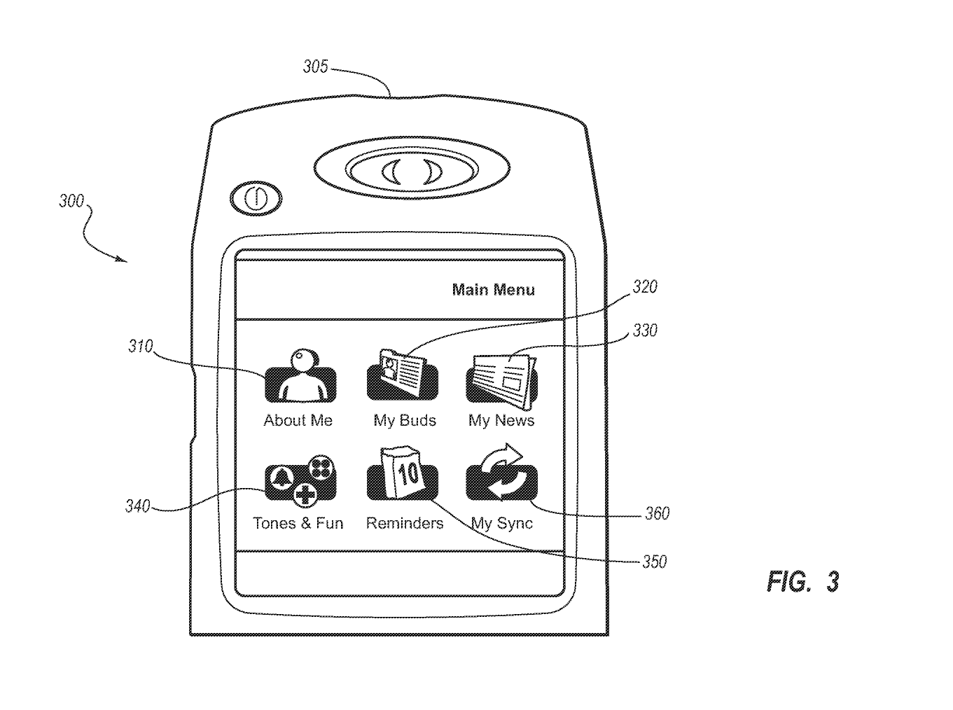

Various examples of various types of profile information and how they are displayed on a mobile device are described in more detail below. The profile information described below may be part of a local profile and/or part of a profile stored on a database. The profiles may be synchronized as described above. Turning now to FIG. 3, an example of a Main Menu 300 is illustrated as being displayed on a mobile device 305. The Main Menu includes selectable icons (or links) for various features discussed in further detail hereinafter.

The Main Menu presentation 300 can include a link in a presentation for the user to submit personal information. In this example, the main menu presents an About Me link 310 that can be used for advanced contact information. A My Buds link 320 can be used for the contact information of others including pictures, voice, phone numbers, electronic addresses, and the like. This information may be periodically changed by the other users. A My News link 330 can be used to post news about the user. The content associated with the My News link 330 may be made available only to other members of the network, or to other users in a particular group, for example. A Tones & Fun link 340 can direct a user to purchase content and to tag content. A Reminders link 350 may be used for alerts, and a My Sync link 360 can be used to synchronize with other users including those that are members of the network or other groups. Such changes may be synched with the profile and local profiles associated with the mobile device such that changes made to the information of the others may be reflected in the display of corresponding presentations as described below.

FIGS. 4A and 4B illustrate examples of an About Me presentation 400 that is retrieved when the About Me link 310 (FIG. 3) is selected. Examples of information describing a user that can be submitted include pictures, name, date, personal description, phone number, birthday, email, favorites, and any other information describing the user. The information is stored on a server, which can be accessed by the user as described above. The user can edit and choose to broadcast the information. The About Me presentation 310 can also include a visual description indicating other Insiders online, the number of favorites recorded, and the number of pictures taken, uploaded, or otherwise stored by the user.

In one embodiment, users that are Insiders can share About Me presentations. The users may share the About Me presentations in a number of ways. For example, the users may select Insiders to which links to the About Me presentations may be posted. The creation of groups will be discussed in more detail below. In addition, the users may share some or all of the About Me presentations with Insiders when the users make voice calls to the other Insiders. In such an example, the About Me presentation may be transmitted from one Insider's mobile device to other Insider's mobile devices at the same time a phone call is made to the other mobile device.

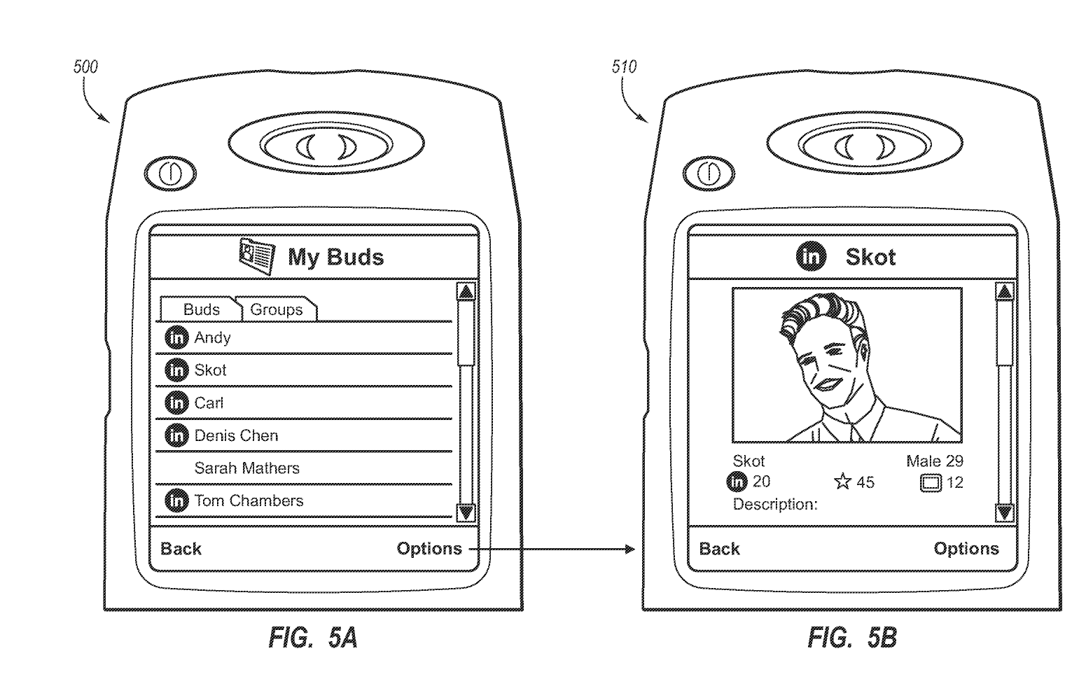

Turning again briefly to FIG. 3, the Main Menu presentation 300 includes the My Buds link 320 associated with a presentation for associating the user with various contacts and organizing contacts. For example, referring now to FIGS. 5A and 5B illustrate examples of a My Buds presentation 500 that may be accessed when the My Buds link 320 is selected. The My Buds presentation 500 can display a list of user-added contacts 510. Contacts who are Insiders may also be indicated, for example by an icon 520 next to the contact name. Non-Insiders and contacts of another wireless carrier or not subscribing to enhanced social features can also be visually identified by specific colors or icons. Users can add, delete, and sort their contacts. For contacts that are also Insiders, the user can navigate to a presentation providing information about the contact, such as receiving and displaying the information entered into an About Me presentation by the contact as illustrated in FIG. 5B. Turning again briefly to FIG. 5A, the My Buds presentation 500 may include a link, illustrated as a group tab 530, which allows users to set up user created groups.

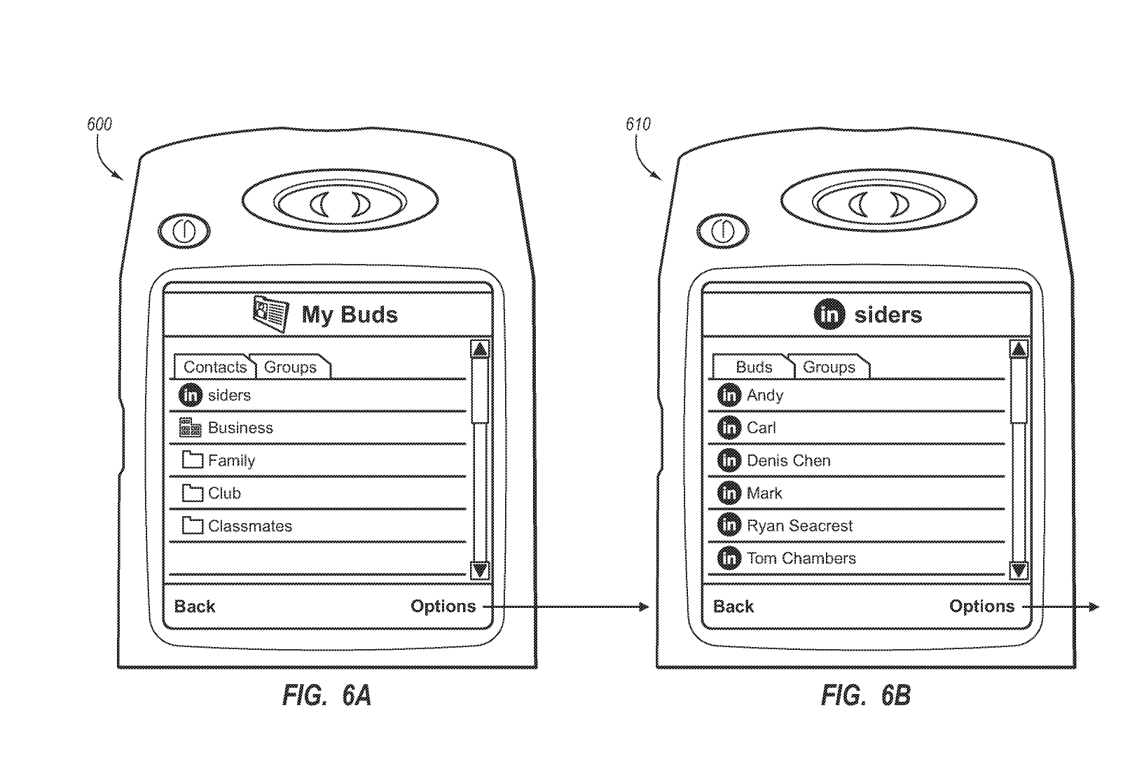

FIGS. 6A and 6B illustrate a Group Selection presentation 600 associated with the My Buds presentation 500. Users can also set up user created groups as illustrated in FIGS. 6A and 6B. The groups can include lists of users that are members of the Insider network. The groups can be created by the user of the mobile electronic device based on various criteria. For example, a group can be a list of family members, coworkers, businesses, members of clubs, and classmates. The list may include links that access a corresponding presentation, such as the Insiders Group presentation 610 illustrated in FIG. 6B.

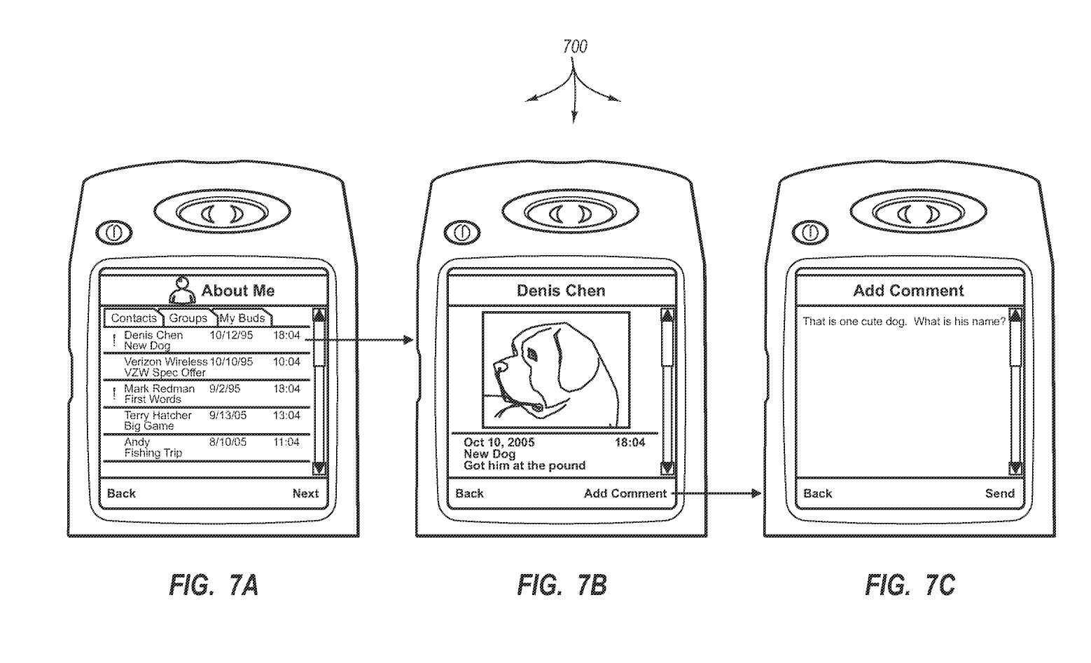

Turning again briefly to FIG. 3, the Main Menu presentation 300 illustrated includes a My News link 330 that when selected accesses a My News presentations 700, 710, and 720, as illustrated in FIGS. 7A-7C respectively. As illustrated in FIG. 7A, the My News presentation 700 may allow a user to access Insider posts and special offers from services. Here, Insiders can post news about important events in their lives and other users, such as friends and family or other insiders in a particular group, may be automatically notified of any posts. The My News presentation can also include Insider related alerts and may only be accessible to members of the Insider network. The user can create posts and send them to a group or single users of other mobile electronic devices. Users can submit pictures to their own My News presentation and allow other members of the Insider network to view and comment on the pictures or other posted content (video, text, etc.). The users can then access the comments to the submitted pictures or other content as illustrated in FIGS. 7B and 7C. The pictures or other content can be displayed with a numerical indication of the number of comments submitted for each picture.

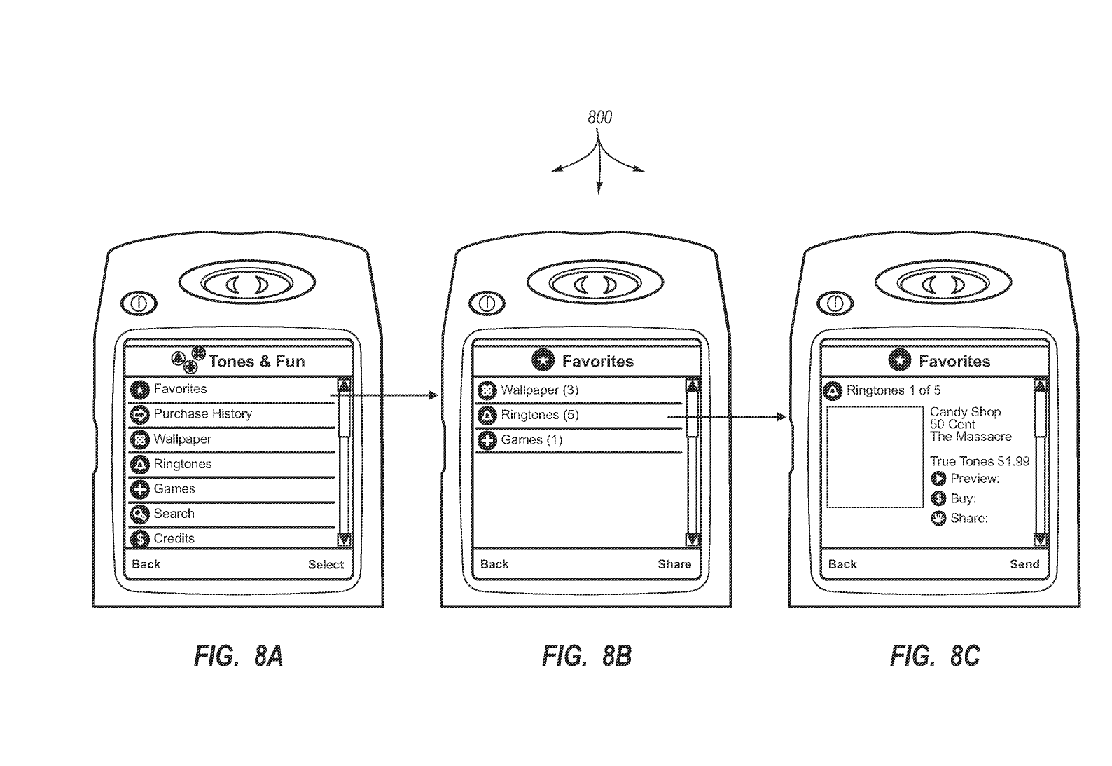

FIGS. 8A-8C illustrate one example of a Tones and Fun presentation 800 that may be accessed by selecting the Tones and Fun link 340 (FIG. 3). As illustrated in FIG. 8A, the Tones and Fun presentation provides an interface for browsing and purchasing media. The media can include data such as graphics, games, video, and/or audio. The media can also be an electronic card for various occasions, such as holidays, birthdays, or events. The electronic greeting cards are capable of being customized by the user by inputting text. The user can then purchase and send the media or electronic greeting card to another member of the Insider network. In some instances, the text may be converted to and saved as an audio file. As illustrated in FIG. 8B, the Tones and Fun presentation 800 may allow users to tag media as a favorite. The user can return to view the media that was tagged as a favorite to help locate and purchase the media at a later date, as illustrated in FIG. 8C.

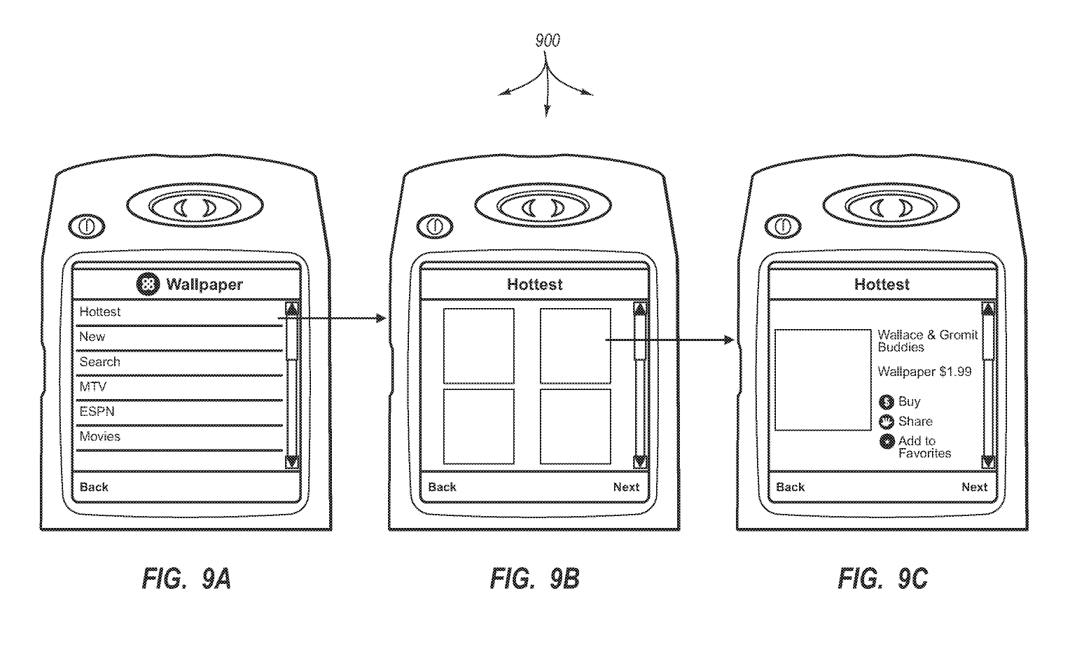

The number of times media has been tagged as a favorite can be tallied and displayed, or media can be organized based on the number of times that the media has been tagged such that more frequently tagged media is offered to users first in a “hot” list, as illustrated the presentation 900 shown in FIGS. 9A-9C. The tagging of media by a particular user can also be analyzed to determine the interests of the user and to supply media, advertising, and special offers to the user based on the user's tagged favorites.

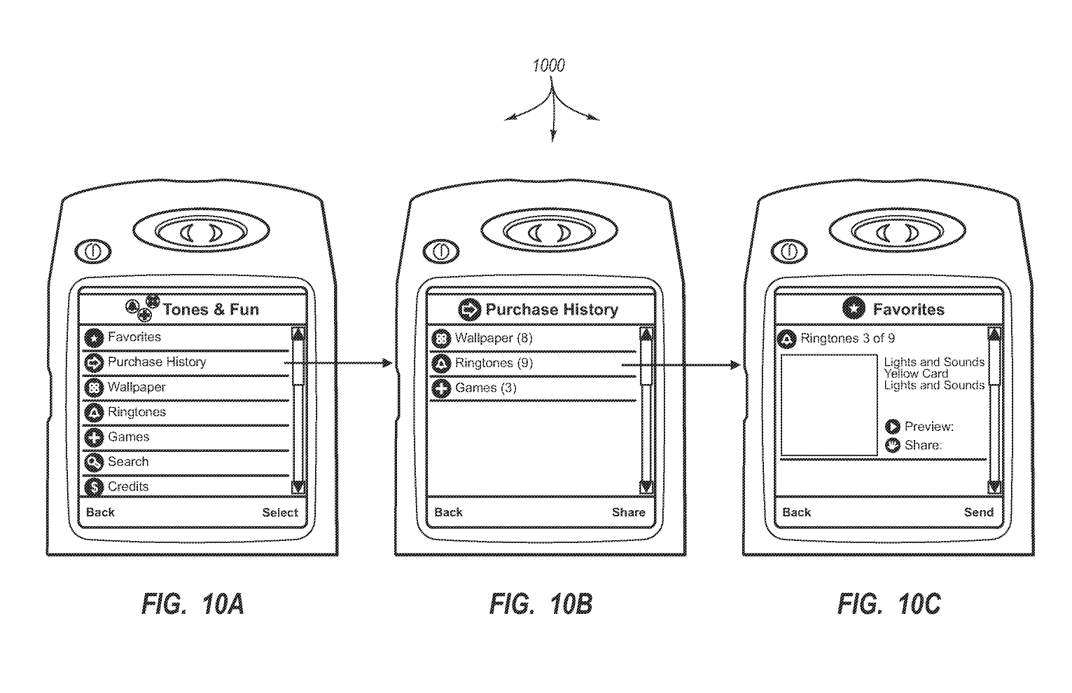

As illustrated in FIG. 10A-10C, a purchase history presentation 1000 can also be displayed and can be organized according to categories, such as the number of wallpapers, ringtones, games, etc. purchased by the user. The media can be organized according to categories and popularity. The user can also be allowed to purchase the media and send media to other users. The statistics associated with the various media can be determined from the user's contacts, from all users, or based on purchase histories, and the like.

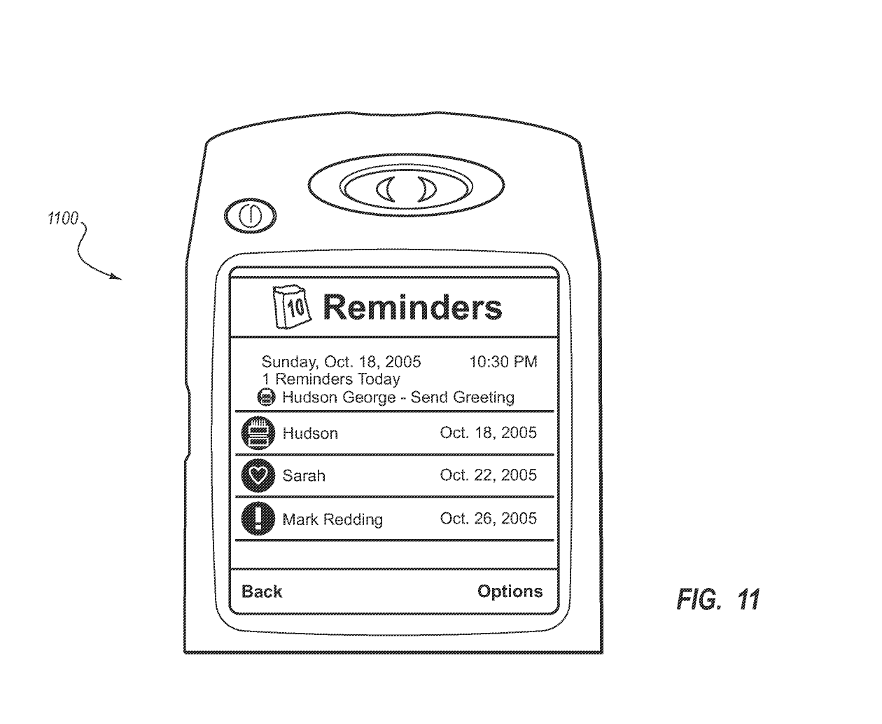

FIG. 11 illustrates a reminder presentation 1100 where users can set up and receive alerts based on calendar dates. As illustrated in FIG. 11, the reminder presentation 1100 can allow a user to create date specific reminders 1110, such as for birthdays, anniversaries, or any other event and can include text and icons related to the events. Reminders can also be set up automatically when a user is added to a group or a list of friends. For example, where a user has entered information describing the user's birthday, all members of a group can have reminders automatically created.

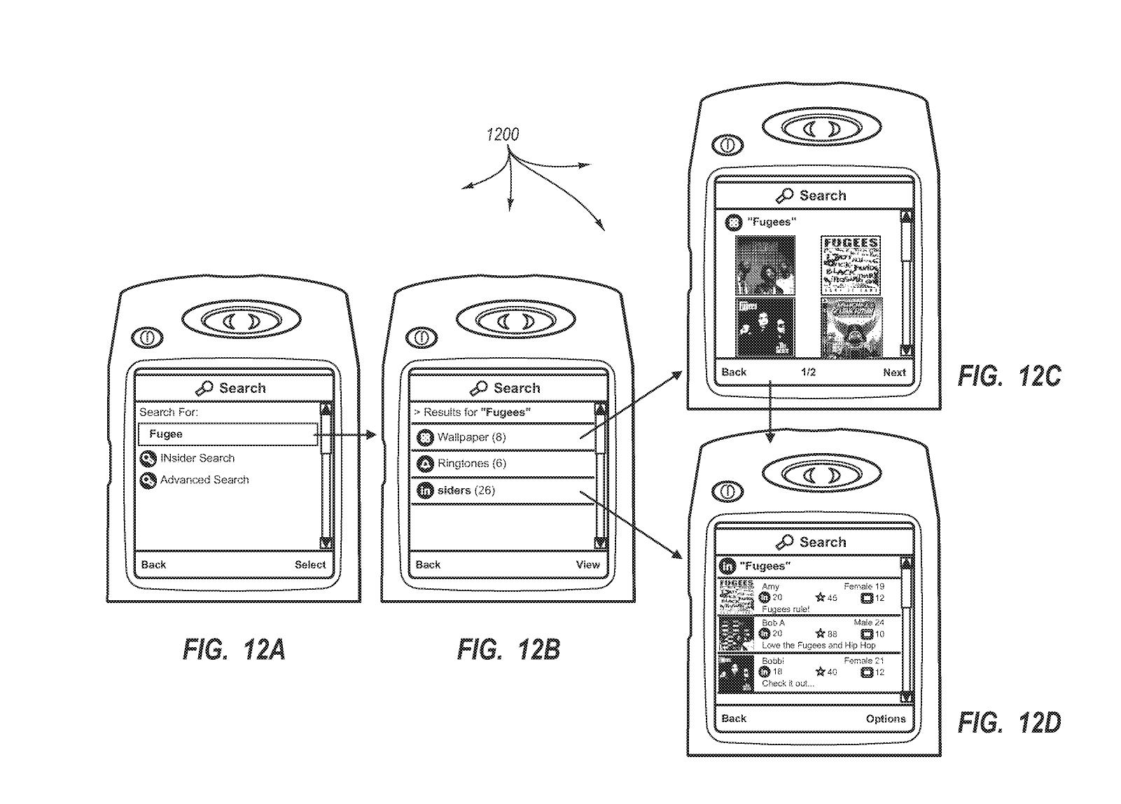

The Main Menu can further include a link to a searching presentation for searching the Insider network for various information, users, and media using keywords. FIGS. 12A-12D illustrate a presentation 1200 for searching for content within the Insider network. For example, a user can search for wallpaper, ringtones, other user's information, etc. The user can also input a general keyword and the Insider network can search for media and users associated with that keyword. For example, a user can input the name of a musical band to search the Insider network for return lists of media and user's information associated with that musical band. The list of users can be associated with the musical band if they have tagged media, such as wallpaper or ringtones, as a favorite or have otherwise been associated with the musical band as a favorite. The list of users can include small pictures supplied by the users along with additional information about the groups to which the users belong and number of pictures submitted by each user.

Users can also use the Insider network as a source of referral and endorsement. For example, a user can search the Insiders for recommendations of contractors or other servicemen. In response, the user can receive a description of the recommended person or company and their contact information. The Insider network can also be searched to locate other users that have similar interests or that match particular criteria, such as attending a particular school.

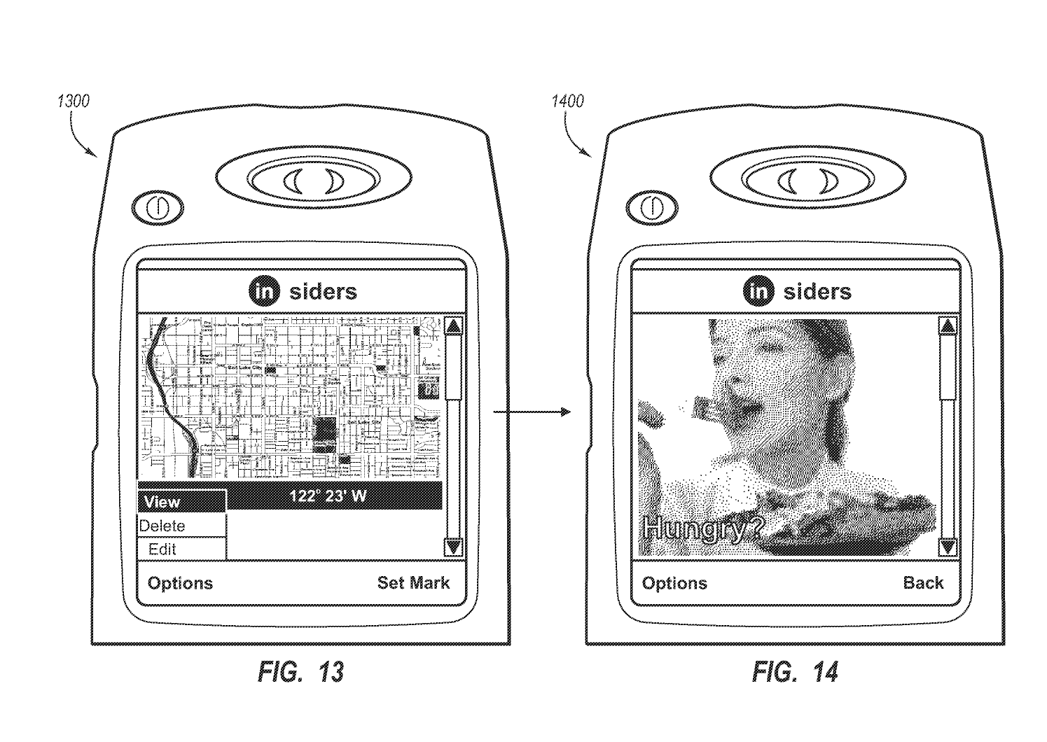

Various user features can also be enabled based on the user's location. These location-based features use information describing the actual location of selected users to enable additional social networking functionality. Once a location of a user is known, for example using a satellite enabled positioning system (such as a Global Positioning System) or other locating device, proximity to other users can be determined. For example, in the presentation 1300 as illustrated in FIG. 13, where the location of two users is known, the direction and distance from one user to the other can be displayed.

Location-based messages can also be sent or posted. For example, referring to the presentation 1400 of FIG. 14, a user can post a message regarding a location, such as a restaurant. When another user approaches or is found near the location, such as a restaurant, they receive a message on their mobile electronic device. The message can include text and pictures; for example, showing a picture of the user who posted the location-based message eating at the restaurant as illustrated. In this case, the determination of when to deliver a message can have location considerations, such as the location of the user that posted the message and the location of the user to whom the message is delivered. In this instance, the delivery of a message may be scheduled according to the respective locations or users.

In addition to the above presentations and user interface taking place on the mobile electronic device, the social networking can also be associated and synchronized with a web-hosted user interface, such as may be provided by a computing device that accesses a server by way of a network. A user can perform any of the functionality discussed above using a web-based application, and information submitted as well as changes made online or using the mobile electronic device can be synchronized. For example, using the online web site, the user can enter user information, add or delete buddies, set up reminders, purchase media, discover locations of other users, and view posts. Thus, the user can use a web-hosted version of various functionalities available on the mobile electronic device, and information entered using the mobile electronic device and the website can be synchronized.

As previously discussed, in at least one example any changes made can be automatically pushed to the user's device in order to synchronize the phone. In another embodiment, a user can manually synchronize his or her device or synchronization may occur periodically.

In another embodiment, information posted, for example, by a user to the My News presentation may also be posted to a web page at the same time. As a result, this creates a relationship between the user's device and the user's web page. Other users can then interact with a user's device via an IP-based network through a web page or using a similar device. For example, a new picture that is posted to the My News presentation is also posted to the user's website automatically. Other users can comment online at the user's webpage and the comments can be synchronized to the original user's My News presentation. Alternatively, other users can also comment on a new picture as described herein.

Embodiments of the present invention may include or be conducted using a special purpose or general-purpose computer, processor, or logic device including various computer hardware and devices, as discussed in greater detail herein or known to one of ordinary skill. Embodiments within the scope of the present invention can also include computer-readable media for carrying or having computer-executable instructions or data structures stored thereon. Such computer-readable media can be any available media that can be accessed by a general-purpose computer, special-purpose computer, or a logic device. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of computer-executable instructions or data structures, and which can be accessed by a general-purpose computer, special-purpose computer, or other logic device.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Embodiments may also employ a messaging system such as SMS or MMS. Various combinations of the above should also be included within the scope of computer-readable media. Computer-executable instructions comprise, for example, instructions, logic, and data that cause a general-purpose computer, special-purpose computer, or logic device to perform a certain function or group of functions.

Each of the processors described herein can be a single conventional general-purpose computer, special-purpose computer, or logic device, or each processor can be multiple processors including multiple conventional general-purpose computer, special-purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the present invention. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method for social networking, comprising:
storing at least one profile on at least one server, the profile being associated with at least one local profile on a mobile device and wherein each of the profile and the local profile includes social networking information;
receiving changes to one of the profile and the local profile; and
synchronizing the profile and the local profile.

2. The method of claim 1, wherein receiving changes to the profile includes receiving changes over a global network.

3. The method of claim 1, wherein receiving changes to the local profile includes receiving changes on the mobile device.

4. The method of claim 1, wherein synchronizing the profile and the local profile is performed automatically when receiving the changes is complete.

5. The method of claim 1, wherein at least one local profile on a mobile device includes at least one mobile device on a cellular telephone-enabled mobile device.

6. The method of claim 1, wherein storing a profile including social networking information includes at least one of personal information for a user, contact information for others within the social network, personal news, information related to media content, and reminders.

7. The method of claim 1, wherein the mobile device receives changes to the local profile, the mobile device stores the changes to the local profile, prepares an update related to the changes to the local profile, and transmits the update to the server.

8. The method of claim 1, wherein the server receives changes to the profile, the server stores the changes to the profile, prepares an update related to the changes to the profile, and transmits the update to the mobile device.

9. The method of claim 1, wherein the social networking information includes information associated with other profiles and further comprising a step of preparing at least one update to update at least one of the other profiles.

10. In a first mobile device, a method of communicating social networking information associated with at least one profile stored on the first mobile device and voice data with a second mobile device, the method comprising:
transmitting voice data for reception by the second device; and
simultaneously transmitting at least a portion of the social networking information to the second mobile device.

11. The method of claim 10, wherein transmitting at least a portion of the social networking information includes a contact information presentation.

12. A method of providing telephone service, comprising:
receiving voice information from a first mobile device;
receiving social networking information simultaneously with receiving the voice information; and
transmitting the voice information and the social networking information to a second mobile device.

13. The method of claim 12, wherein receiving and transmitting the social networking information includes receiving and transmitting a contact information presentation.

14. A method for social networking comprising:
receiving information linked to a first mobile electronic device subscribing to a wireless service;
associating the first mobile electronic device with information stored from other mobile electronic devices based on the information received;
querying information stored from the other mobile electronic devices; and
transmitting a result of the query to the first mobile electronic device.

15. The method of claim 14, wherein the information received from the first mobile electronic device describes a location of the first mobile electronic device.

16. The method of claim 15, wherein the information queried includes information describing a location of a second mobile electronic device.

17. The method of claim 16, further comprising calculating a direction of travel from the location of the first mobile electronic device to the location of the second mobile electronic device.

18. The method of claim 16, further comprising calculating a distance between the first mobile electronic device and the second mobile electronic device.

19. The method of claim 16, further comprising receiving a message from the first mobile electronic device and associating the message with the location of the first mobile electronic device.

20. The method of claim 19, further comprising transmitting the message to the second mobile electronic device when the location of the second mobile electronic device is near the location associated with the message.

21. The method of claim 14, further comprising receiving from the first mobile electronic device a selection of a group of the other mobile electronic devices, and creating a list of information describing the group of other mobile electronic devices.

22. The method of claim 21, further comprising at least one of receiving a message from the first mobile electronic device, and transmitting the message to each of the mobile electronic devices listed in the group, receiving a reminder associated with a date and including a message from the first mobile electronic device, and transmitting the reminder to each of the mobile electronic devices listed in the group; and receiving information from the first mobile electronic device describing a media file as a favorite.

23. The method of claim 22, further comprising tallying the selection of the media file as a favorite received from the first mobile electronic device with other selections of the media file as a favorite received from other mobile electronic devices.

24. The method of claim 23, further comprising organizing the media files along with other media files based on the number of time each media file has been selected as a favorite.

25. The method of claim 23, further comprising transmitting a value representing the number of times the media file has been selected as a favorite to the first mobile electronic device.
